(19) United States
(12) Patent Application Publication
(10) Pub. No.: US 2023/0178983 A1
(43) Pub. Date: Jun. 8, 2023

(54) FAST AND FLEXIBLE HOLOMORPHIC EMBEDDING-BASED METHOD FOR ASSESSING POWER SYSTEM LOAD MARGINS

(71) Applicant: SUN YAT-SEN UNIVERSITY, Guangzhou, Guangdong (CN)

(72) Inventors: Tao WANG, Guangzhou, Guangdong (CN); Wen ZHANG, Guangzhou, Guangdong (CN); Wentao HUANG, Guangzhou, Guangdong (CN); Jiaqi LI, Guangzhou, Guangdong (CN)

(21) Appl. No.: 17/923,712

(22) PCT Filed: Jan. 26, 2022
(86) PCT No.: PCT/CN2022/074123

§ 371 Date: Nov. 7, 2022

(30) Foreign Application Priority Data
Feb. 4, 2021 (CN) 202110154748.7

(51) Int. Cl. H02J 3/00; H02J 13/00; G05B 19/042

(52) U.S. Cl. CPC H02J 3/003; H02J 13/00002; G05B 19/042; G05B 2219/2639

(57) ABSTRACT

A fast and flexible holomorphic embedding-based method for assessing power system load margins includes the following steps: S1, acquiring required decrypted power system data from a partner indirectly; S2, establishing a system of continuation power flow equations; S3, solving the continuation power flow equation by FFHE; and S4, designing and planning a scheduling policy for the power system based on the solved load margin. Compared with prediction through a linear function, the present method is considerably precise and efficient by utilizing rational approximants obtained by expanding arc-length series without repeatedly applying a local solver inefficiently and multifariously for correction. An efficient solution is developed to solve this type of nonlinear equations efficiently. Compared with existing methods, the present method is significantly improved in computational efficiency, computational accuracy, solvable system scale and the like.

### TECHNICAL FIELD

The present invention relates to the technical field of electric power, and particularly to a fast and flexible holomorphic embedding-based method for assessing power system load margins.

### BACKGROUND

As national economy develops and domestic standard of living improves, the capacity of loads in power grid keeps growing, and cutting off power supply will greatly impact the domestic life. Owing to the development of wide-area interconnected power grids incorporating large units, ultra-high voltage transmission, and renewable energy, the power system operates much closer to the power limit, and consequently the stability issue becomes severer. Moreover, as the uncertainties caused by renewable energy, the power system thus would suffer from the problem such as overloading or power fluctuation, and result in voltage instability and further wide-area power outage and blackout. Therefore, it necessitates the assessment of power system load margins beforehand when planning and scheduling the operation of a large power system.

P-V curve analysis is an important tool for accessing the power system load margin. P represents an overall load of a certain area or a transmission power of inter-area links between transmission sections, V represents a voltage at a certain bus. The two parameters can indicate the degree of stability that can be maintained at each load bus, and then determine the load margin of the system. As observed by tracking the P-V curve, when the load power reaches the critical point and further increases slightly, the voltage can drop significantly, resulting in system voltage instability and even voltage collapse. The critical point is called a saddle node bifurcation (SNB) point in mathematics. The common power flow methods (such as Newton's and fast decoupled methods) are developed from the conventional iterative methodology, can encounter the numerical failure and divergence because it needs to compute a nearly-singular Jacobian matrix when the system operates close to the critical point, and then cannot track the full P-V curve. So, some scholars have proposed the continuation power flow method (CPFLOW method) based on the arc-length parametrization, which usually applies a conventional method such as Euler's method, trapezoidal rule for integration, or Runge-Kutta method during the prediction step, utilizes a local solver for the correction step, and repeats them until the P-V curve is traced down for adequate length (or it passes the SNB point). In addition, some other scholars have proposed alternative methods for tracking the P-V curve, that is, applying the polynomial approximant at the prediction step and also the holomorphic embedding (HE) method at the correction step. However, both of the above methods have great limitations.

First of all, the shortcomings of CPFLOW include:

(i) Since the prediction step employs the linear approximant as the predictor, the quality of approximation is poor, and particularly, it needs very short step-size when simulating a large complex system.

(ii) It is hard to determine the step size. Albeit the accuracy is really improved if selecting a sufficiently small step-size, it will increase both the number of times of evaluating the derivatives and that of using the local solver, which significantly undermines the numerical efficiency. On the other hand, a large step-size can harm the accuracy of curve approximation or even result in divergence, especially in the vicinity of the critical point.

(iii) At the correction step, owing to the limited convergence region of the iterative local solver (such as the Newton-Raphson method), it may also suffer from the issue of divergence as the system size grows, even if a relatively-small step-size is used for the prediction.

Furthermore, when obtaining the series expansion by an existing HE method, taking the control parameter in the continuation power flow equation for the parametrization can reduce the time cost of calculating series coefficients but also brings about a fatal flaw: it only can empirically estimate the location of SNB by observing the start of the oscillating curve but without theoretical basis, where the start of oscillation is located significantly different from the actual SNB point in general.

### SUMMARY

Given the above-mentioned defects in the prior art, the present invention intends to provide a method and system for assessing power system load margins based on fast and flexible holomorphic embedding to overcome the shortcomings in the prior art.

To accomplish the above goals, the present invention provides a fast and flexible holomorphic embedding-based method for assessing power system load margins, including the following steps:

step S1, acquiring required decrypted power system data from a partner indirectly;

step S2, establishing a system of continuation power flow equations;

step S3, solving the system of continuation power flow equations by FFHE (fast and flexible holomorphic embedding); and

step S4, designing and planning a scheduling policy of the power system based on the solved load margin.

Further, establishing a system of continuation power flow equations in step S2 includes the details as:

A power flow problem is commonly described as the following algebraic equations:

Sᵢ=VᵢΣₖY*_{i,k}V*ₖ, (1)

where Sᵢ=Pᵢ+jQᵢ represents a power injection at a bus, Pᵢ, Qᵢ represent active and reactive powers, respectively, at bus i, Y_{i,k}=G_{i,k}+jB_{i,k} is an admittance between corresponding buses, G_{i,k}, B_{i,k} represent a conductance and a susceptance, respectively, between corresponding buses, Y*_{i,k}, V*ₖ represent conjugates of Y_{i,k}, Vₖ, respectively, and Vᵢ represents a bus voltage; equation (1) can be converted to the rectangular form as:

Pᵢ=Vᵢ^{R}Σₖ{G_{i,k}Vₖ^{R}−B_{i,k}Vₖ^{I}}+Vᵢ^{I}Σₖ{B_{i,k}Vₖ^{R}+G_{i,k}Vₖ^{I}};

Qᵢ=−Vᵢ^{R}Σₖ{B_{i,k}Vₖ^{R}+G_{i,k}Vₖ^{I}}+Vᵢ^{I}Σₖ{G_{i,k}Vₖ^{R}−B_{i,k}Vₖ^{I}}; (2)

where Vₖ^{R} is a real part of the bus voltage, while Vₖ^{I} is an imaginary part of the bus voltage; and

by equation (2), a continuation power flow equation can be constructed as

Vᵢ^{R}Σₖ{G_{i,k}Vₖ^{R}−B_{i,k}Vₖ^{I}}+Vᵢ^{I}Σₖ{B_{i,k}Vₖ^{R}+G_{i,k}Vₖ^{I}}−Pᵢ−λ·(P_{targ,i}−P_{base,i})=0;

−Vᵢ^{R}Σₖ{B_{i,k}Vₖ^{R}+G_{i,k}Vₖ^{I}}+Vᵢ^{I}Σₖ{G_{i,k}Vₖ^{R}−B_{i,k}Vₖ^{I}}−Qᵢ−λ·(Q_{targ,i}−Q_{base,i})=0; (3)

where λ is a real number, P_{targ,i}, P_{base,i} represent a target value and a base value of the active power at a load bus, respectively, and Q_{targ,i}, Q_{base,i} represent a target value and a base value of the reactive power at the load bus, respectively.

Further, step S3 specifically includes:

step S301, initializing and setting an order of series expansion qₘₐₓ, a threshold of the acceptable mismatch e between two sides of the equation, and a given entry of at least one part in the initial point X₀=(V^{R}(0), V^{I}(0), λ(0));

step S302, introducing a new parameter s and obtaining an embedding system;

$${\sum }_{k} \{ {( \frac{{dV}_{k}^{R}}{ds} )}^{2} ( s ) + {( \frac{{dV}_{k}^{I}}{ds} )}^{2} ( s ) \} + {( \frac{d λ}{ds} ( s ) )}^{2} = 1 ;$$

$${V}_{i}^{R} ( s ) {\sum }_{k} \{ {G}_{i , k} {V}_{k}^{R} ( s ) - {B}_{i , k} {V}_{k}^{I} ( s ) \} + {V}_{i}^{I} ( s ) {\sum }_{k} \{ {B}_{i , k} {V}_{k}^{R} ( s ) + {G}_{i , k}^{I} {V}_{k}^{I} ( s ) \} - {P}_{i} - λ ( s ) \cdot ( {P}_{targ , i} - {P}_{base , i} ) = 0 ;$$

$$- {V}_{i}^{R} ( s ) {\sum }_{k} \{ {B}_{i , k} {V}_{k}^{R} ( s ) + {G}_{i , k} {V}_{k}^{I} ( s ) \} + {V}_{i}^{I} ( s ) {\sum }_{k} \{ {G}_{i , k} {V}_{k}^{R} ( s ) - {B}_{i , k} {V}_{k}^{I} ( s ) \} - {Q}_{i} - λ ( s ) \cdot ( {Q}_{targ , i} - {Q}_{base , i} ) = 0 ;$$

step S303, representing λ(s), V^{R}(s), V^{I}(s) as series expansions in s;

λ(s)=Σ_{q≥0}a_{0,q}s^{q}; Vₖ^{R}(s)=Σ_{q≥0}a_{k,q}s^{q},Vₖ^{I}(s)=Σ_{q≥0}b_{k,q}s^{q},k≥1;

step S304, inserting the series expansion into the embedded system, and obtaining a system of equations by taking series coefficients in the series expansions as the unknowns:

Σ_{k≠ref}{(Σ_{q≥0}(1+q)·a_{k,q+1}s^{q})²+(Σ_{q≥0}(1+q)·b_{k,q+1}s^{q})²}+(Σ_{q≥0}(1+q)·a_{0,q+1}S^{q})²=1;

{Σ_{q≥0}a_{i,q}s^{q}}·Σₖ{G_{i,k}Σ_{q≥0}a_{k,q}s^{q}−B_{i,k}Σ_{q≥0}b_{k,q}s^{q}}+{Σ_{q≥0}b_{i,q}s^{q}}·Σₖ{B_{i,k}Σ_{q≥0}a_{k,q}s^{q}+G_{i,k}Σ_{q≥0}b_{k,q}s^{q}}−Pᵢ−{Σ_{q≥0}a_{0,q}s^{q}}·(P_{targ,i}−P_{base,i})=0;

−{Σ_{q≥0}a_{i,q}s^{q}}·Σₖ{B_{i,k}Σ_{q≥0}a_{k,q}s^{q}+G_{i,k}Σ_{q≥0}b_{k,q}s^{q}}+{Σ_{q≥0}b_{i,q}s^{q}}·Σₖ{G_{i,k}Σ_{q≥0}a_{k,q}s^{q}−B_{i,k}Σ_{q≥0}b_{k,q}s^{q}}−Qᵢ−{Σ_{q≥0}a_{0,q}s^{q}}·(Q_{targ,i}−Q_{base,i})=0;

step S305, comparing the coefficients of the terms with a same order of s, wherein when q=0,

a_{k,0}=Vₖ^{R}(0), b_{k,0}=Vₖ^{I}(0), 1≤k≤n; a_{0,0}=λ(0)=λ₀; a_{i,0}·Σₖ{G_{i,k}a_{k,0}−B_{i,k}b_{k,0}}+b_{i,0}·Σₖ{B_{i,k}a_{k,0}+G_{i,k}b_{k,0}}−Pᵢ−a_{0,0}·(P_{targ,i}−P_{base,i})=0;

−a_{i,0}·Σₖ{B_{i,k}a_{k,0}+G_{i,k}b_{k,0}}+b_{i,0}·Σₖ{G_{i,k}a_{k,0}−B_{i,k}b_{k,0}}−Qᵢ−a_{0,0}·(Q_{targ,i}−Q_{base,i})=0;

selecting at least one of a_{0,0}, a_{k,0}, b_{k,0} as a known initial value, to solve all a_{0,0}, a_{k,0}, b_{k,0};

step S306, comparing the coefficients of the terms with a same order of s, where when q=1,

Σₖ{a_{k,1}²+b_{k,1}²}+(a_{0,1})²=1; (5)

a_{i,0}·Σₖ{G_{i,k}a_{k,1}−B_{i,k}b_{k,1}}+a_{i,1}·Σₖ{G_{i,k}a_{k,0}−B_{i,k}b_{k,0}}+b_{i,0}·Σₖ{B_{i,k}a_{k,1}+G_{i,k}b_{k,1}}+b_{i,1}·Σₖ{B_{i,k}a_{k,0}+G_{i,k}b_{k,0}}−a_{0,1}·(P_{targ,i}−P_{base,i})=0; (6)

−a_{i,0}·Σₖ{B_{i,k}a_{k,1}+G_{i,k}b_{k,1}}−a_{i,1}·Σₖ{B_{i,k}a_{k,0}+G_{i,k}b_{k,0}}+b_{i,0}·Σₖ{G_{i,k}a_{k,1}−B_{i,k}b_{k,1}}+b_{i,1}·Σₖ{G_{i,k}a_{k,0}−B_{i,k}b_{k,0}}−a_{0,1}·(Q_{targ,i}−Q_{base,i})=0; (7)

where a_{0,0}, a_{k,0}, b_{k,0} herein are known;

step S307, deriving rational approximants using the series expansions of λ(s), V^{R}(s), V^{I}(s);

step S308, substituting a value of the rational approximant at s=s₀ into the equation (3), and making a comparison to figure out whether the mismatch between a left side and a right side of the equation is smaller than a preset acceptable threshold e; if yes, expanding s₀ till the mismatch is not smaller than the preset acceptable threshold; if no, shrinking s₀ till the mismatch is smaller than the preset acceptable threshold, i.e., returning s₀ as great as possible with the mismatch smaller than the threshold e;

step S309, taking (V^{R}(s₀), V^{I}(s₀), λ(s₀)) as anew initial point X₀; and

step S310, repeating S302 to S309 till pinpointing an SNB point.

The present invention has the beneficial effects that

1. The present invention provides a new P-V curve tracking method based on arc length parameterization and using piecewise rational approximants, which can effectively avoid defects of the above-mentioned two existing methods. The arc-length parameter is employed for parametrization when deriving the series expansion, which ensures that the P-V curve tracked can pass the SNB point and enjoys a solid theoretical foundation. In comparison with the linear predictor, rational approximants are more accurate and efficient; and there is no need to repeatedly apply the local solver for correction in an inefficient and complicated manner.

2. When applying the arc-length parametrization, the series coefficients of linear terms (i.e., first-order terms) needs to be solved from a system of nonlinear equations, it can account for the majority of the runtime if this computational task is not properly processed. The present invention develops an effective scheme to efficiently solve such type of nonlinear equations.

3. The present invention employs the piecewise rational approximants for the approximation, only needs to divide the concerned interval into a few subintervals to accurately approximate the actual P-V curve, and shows significant improvements in numerical efficiency, accuracy, and solvable scale, and so on by taking the performance of existing methods as the baseline.

4. The present invention only needs to store the coefficients in rational approximants and length of subintervals for the few subintervals and significantly reduces the required memory space, while CPFLOW needs to costly retain the solution values at thousands of individual points to characterize a P-V curve.

Further descriptions will be provided to explain the plot, concrete structure, and technical benefits of the present invention in conjunction with the accompanying drawings, to fully understand the purposes, features and effects of the present invention.

### BRIEF DESCRIPTION OF DRAWINGS

FIG. 1 is a processing flowchart of FFHE for solving a continuation power flow equation of the present invention.

FIG. 2 is a schematic diagram showing that a scheduling center provides power system load margins of the present invention.

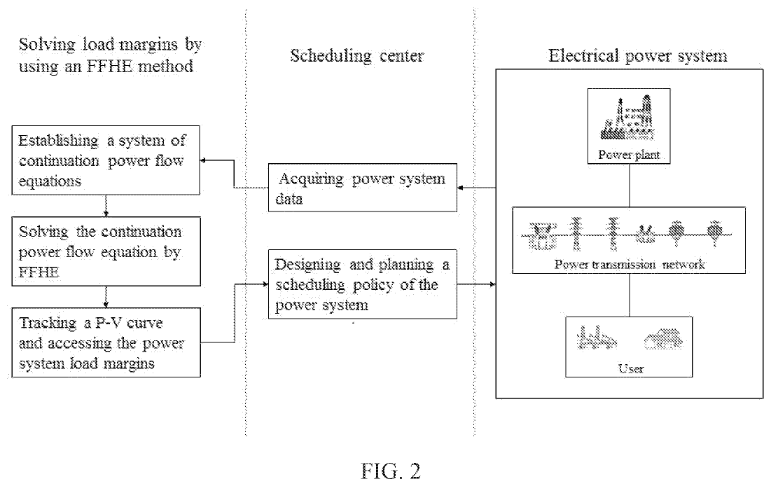

### DETAILED DESCRIPTION OF EMBODIMENTS

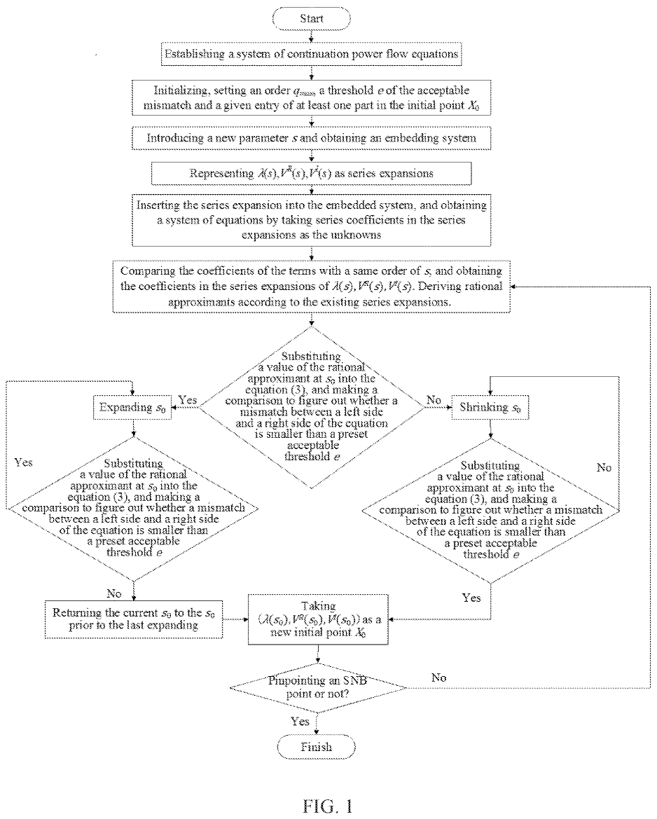

As shown in FIG. 1, the present invention provides a fast and flexible holomorphic embedding-based method for assessing power system load margins, mainly including the following steps:

Step S1, as the original power system data are confidential, the required decrypted power system data are acquired from a partner indirectly.

Step S2, a system of continuation power flow equations is established.

For brevity, a PQ bus is only discussed here, while a PV bus can be processed similarly.

A power flow problem is commonly described as the following algebraic equations:

Sᵢ=VᵢΣₖY*_{i,k}V*ₖ, (1)

where Sᵢ=Pᵢ+jQᵢ represents a power injection at a bus, Pᵢ, Qᵢ represent active and reactive powers, respectively, at bus i, Y_{i,k}=G_{i,k}+jB_{i,k} is an admittance between corresponding buses, G_{i,k}, B_{i,k} represent a conductance and a susceptance, respectively, between corresponding buses, Y*_{i,k}, V*ₖ represent conjugates of Y_{i,k}, Vₖ, respectively, and Vᵢ represents a bus voltage; equation (1) can be converted to the rectangular form as:

Pᵢ=Vᵢ^{R}Σₖ{G_{i,k}Vₖ^{R}−B_{i,k}Vₖ^{I}}+Vᵢ^{I}Σₖ{B_{i,k}Vₖ^{R}+G_{i,k}Vₖ^{I}};

Qᵢ=Vᵢ^{R}Σₖ{B_{i,k}Vₖ^{R}+G_{i,k}Vₖ^{I}}+Vᵢ^{I}Σₖ{G_{i,k}Vₖ^{R}−B_{i,k}Vₖ^{I}}; (2)

where Vₖ^{R} is a real part of the bus voltage, while Vₖ^{I} is an imaginary part of the bus voltage; and

by equation (2), a continuation power flow equation can be constructed as

Vᵢ^{R}Σₖ{G_{i,k}Vₖ^{R}−B_{i,k}Vₖ^{I}}+Vᵢ^{I}Σₖ{B_{i,k}Vₖ^{R}+G_{i,k}Vₖ^{I}}−Pᵢ−λ·(P_{targ,i}−P_{base,i})=0;

−Vᵢ^{R}Σₖ{B_{i,k}Vₖ^{R}+G_{i,k}Vₖ^{I}}+VₗⁱΣₖ{G_{i,k}Vₖ^{R}−B_{i,k}Vₖ^{I}}−Qᵢ−λ·(Q_{targ,i}−Q_{base,i})=0; (3)

where λ is a real number, P_{targ,i}, P_{base,i} represent a target value and a base value of the active power at a load bus, respectively, and Q_{targ,i}, Q_{base,i} represent a target value and a base value of the reactive power at the load bus, respectively.

Step S3, a continuation power flow equation is solved by FFHE.

For the convenience of description, equation (3) is denoted by f(V^{R}, V^{I}, λ)=0, where V^{R}=(V₁^{R}, V₂^{R}, . . . , Vₖ^{R}, . . . )^{T}, V^{I}=(V₁^{I}, V₂^{I}, . . . , Vₖ^{I}, . . . )^{T}. In order to solve the equation by FFHE, parameter s is introduced, and an arc-length parametrization equation is selected simultaneously therewith.

$${\sum }_{k} \{ {( \frac{{dV}_{k}^{R}}{ds} )}^{2} ( s ) + {( \frac{{dV}_{k}^{I}}{ds} )}^{2} ( s ) \} + {( \frac{d λ}{ds} ( s ) )}^{2} = 1 ; f ( {V}^{R} ( s ) , {V}^{I} ( s ) , λ ( s ) ) = 0 . \qquad ( 4 )$$

While the series expansions of λ(s), V^{R}(s), V^{I}(s):

λ(s)=Σ_{q≥0}a_{0,q}s^{q}; Vₖ^{R}(s)=Σ_{q≥0}a_{k,q}s^{q}, Vₖ^{I}(s)=Σ_{q≥0}b_{k,q}s^{q}, k≥1

are inserted into equation (4), and a system of equations with the unknowns a_{0,q}, a_{k,q}, b_{k,q} (k≥1) can be determined by comparing the coefficients of the terms with a same order of s.

After the above steps are completed, the series expansions of λ(s), V^{R}(s), V^{I}(s) can be obtained. Rational approximants are derived according to the existing series expansions, so as to expand a convergence domain. A value of the rational approximant at s=s₀ is substituted into the equation (3), and whether a mismatch between a left side and a right side of the equation is smaller than a preset acceptable threshold is compared. s₀ as great as possible is found out, so that the mismatch is smaller than the threshold. By taking V^{R}(s₀), V^{I}(s₀), λ(s₀) as a new initial point, the above steps are repeated till the SNB point is pinpointed.

Step S4, a scheduling policy of the power system are designed and planned based on the solved load margin.

As it needs to reserve a certain load margin to cope with change of the load during the operation of a power distribution network, it needs to determine a constraint condition of the scheduling model based on the load margin and design an optimum scheduling policy. When the load margin is as low as a certain degree, a part of load is removed immediately, and at the time, a scheduler shall draw a clear distinction between the primary and the secondary to guarantee the power supply of main areas. Areas with probable voltage collapse can be configured with enough automatic load shedding devices to prevent accidents.

During the specific implementation, the above-mentioned step S3 includes:

Step S301, an order of series expansion qₘₐₓ, a threshold of the acceptable mismatch e between two sides of the equation, and a given entry of at least one part in the initial point X₀=(V^{R}(0), V^{I}(0), λ(0)) are initialized and set.

Step S302, a new parameter s is introduced and an embedding system is obtained:

$${\sum }_{k} \{ {( \frac{{dV}_{k}^{R}}{ds} )}^{2} ( s ) + {( \frac{{dV}_{k}^{I}}{ds} )}^{2} ( s ) \} + {( \frac{d λ}{ds} ( s ) )}^{2} = 1 ;$$

$${V}_{i}^{R} ( s ) {\sum }_{k} \{ {G}_{i , k} {V}_{k}^{R} ( s ) - {B}_{i , k} {V}_{k}^{I} ( s ) \} + {V}_{i}^{I} ( s ) {\sum }_{k} \{ {B}_{i , k} {V}_{k}^{R} ( s ) + {G}_{i , k}^{I} {V}_{k}^{I} ( s ) \} - {P}_{i} - λ ( s ) \cdot ( {P}_{targ , i} - {P}_{base , i} ) = 0 ;$$

$$- {V}_{i}^{R} ( s ) {\sum }_{k} \{ {B}_{i , k} {V}_{k}^{R} ( s ) + {G}_{i , k} {V}_{k}^{I} ( s ) \} + {V}_{i}^{I} ( s ) {\sum }_{k} \{ {G}_{i , k} {V}_{k}^{R} ( s ) - {B}_{i , k} {V}_{k}^{I} ( s ) \} - {Q}_{i} - λ ( s ) \cdot ( {Q}_{targ , i} - {Q}_{base , i} ) = 0 ;$$

Step S303, λ(s), V^{R}(s), V^{I}(s) are represented as series expansions in s:

λ(s)=Σ_{q≥0}a_{0,q}s^{q}; Vₖ^{R}(s)=Σ_{q≥0}a_{k,q}s^{q}, Vₖ^{I}(s)=Σ_{q≥0}b_{k,q}s^{q}, k≥1

Step S304, the series expansion is inserted into the embedding system, and a system of equations is obtained by taking series coefficients in the series expansions as the unknowns:

Σ_{k≠ref}{(Σ_{q≥0}(1+q)·a_{k,q+1}s^{q})²+(Σ_{q≥0}(1+q)·b_{k,q+1}s^{q})²}+(Σ_{q≥0}(1+q)·a_{0,q+1}s^{q})²=1;

{Σ_{q≥0}a_{i,q}s^{q}}·Σₖ{G_{i,k}Σ_{q≥0}a_{k,q}s^{q}−B_{i,k}Σ_{q≥0}b_{k,q}s^{q}}+{Σ_{q≥0}b_{i,q}s^{q}}·Σₖ{B_{i,k}Σ_{q≥0}a_{k,q}s^{q}+G_{i,k}Σ_{q≥0}b_{k,q}s^{q}}−Pᵢ−{Σ_{q≥0}a_{0,q}s^{q}}·(P_{targ,i}−P_{base,i})=0;

−{Σ_{q≥0}a_{i,q}s^{q}}·Σₖ{B_{i,k}Σ_{q≥0}a_{k,q}s^{q}+G_{i,k}Σ_{q≥0}b_{k,q}s^{q}}+{Σ_{q≥0}b_{i,q}s^{q}}·Σₖ{G_{i,k}Σ_{q≥0}a_{k,q}s^{q}−B_{i,k}Σ_{q≥0}b_{k,q}s^{q}}−Qᵢ−{Σ_{q≥0}a_{0,q}s^{q}}·(Q_{targ,i}−Q_{base,i})=0;

Step S305, the coefficients of the terms with a same order of s are compared, wherein when q=0,

a_{k,0}=Vₖ^{R}(0), b_{k,0}=Vₖ^{I}(0), 1≤k≤n; a_{0,0}=λ(0)=λ₀;

a_{i,0}·Σₖ{G_{i,k}a_{k,0}−B_{i,k}b_{k,0}}+b_{i,0}·Σₖ{B_{i,k}a_{k,0}+G_{i,k}b_{k,0}}−Pᵢ−a_{0,0}·(P_{targ,i}−P_{base,i})=0;

−a_{i,0}·Σₖ{B_{i,k}a_{k,0}+G_{i,k}b_{k,0}}+b_{i,0}·Σₖ{G_{i,k}a_{k,0}−B_{i,k}b_{k,0}}−Qᵢ−a_{0,0}·(Q_{targ,i}−Q_{base,i})=0;

at least one of a_{0,0}, a_{k,0}, b_{k,0} is selected as a known initial value, to solve all a_{0,0}, a_{k,0}, b_{k,0}.

Step S306, the coefficients of the terms with a same order of s are compared, wherein when q=1,

Σₖ{a_{k,1}²+b_{k,1}²}+(a_{0,1})²=1; (5)

a_{i,0}·Σₖ{G_{i,k}a_{k,1}−B_{i,k}b_{k,1}}+a_{i,1}·Σₖ{G_{i,k}a_{k,0}−B_{i,k}b_{k,0}}+b_{i,0}·Σₖ{B_{i,k}a_{k,1}+G_{i,k}b_{k,1}}+b_{i,1}·Σₖ{B_{i,k}a_{k,0}+G_{i,k}b_{k,0}}−a_{0,1}·(P_{targ,i}−P_{base,i})=0; (6)

−a_{i,0}·Σₖ{B_{i,k}a_{k,1}+G_{i,k}b_{k,1}}−a_{i,1}·Σₖ{B_{i,k}a_{k,0}+G_{i,k}b_{k,0}}+b_{i,0}·Σₖ{G_{i,k}a_{k,1}−B_{i,k}b_{k,1}}+b_{i,1}·Σₖ{G_{i,k}a_{k,0}−B_{i,k}b_{k,0}}−a_{0,1}·(Q_{targ,i}−Q_{base,i})=0; (7)

where a_{0,0}, a_{k,0}, b_{k,0} herein are known.

For the convenience of description, the to-be-solved equations (5), (6) and (7) are rewritten into

Σᵢ₌₁ⁿxᵢ²=1, Ax=B. (8)

where x=(x₁, . . . , xₙ)^{T} is an unknown vector, A is a matrix with (n−1) rows and n columns, and B is a column vector. At the time, the equation set (8) is solved to obtain a_{0,1}, a_{k,1}, b_{k,1}.

How to solve the equation (8) is introduced below:

First, A is decomposed into A=[A₁, A₂], marked as \tilde{x}₁=\tilde{x}₁, \tilde{x}₂=(x₂, . . . , \tilde{x}ₙ)^{T}·\tilde{x}₂=A₂⁻¹(B−A₁\tilde{x}₁) can be deduced from A₁\tilde{x}₁+A₂\tilde{x}₂=B, and a quadratic equation with one unknown regarding \tilde{x}₁ can be obtained in combination with the equation (8)

\tilde{x}₁²+(B−A₁\tilde{x}₁)^{T}(A₂⁻¹)^{T}(A₂⁻¹)(B−A₁\tilde{x}₁)=1,

can be rewritten as

$${c}_{0} {\tilde{x}}_{1}^{2} + {c}_{1} {\tilde{x}}_{1} + {c}_{2} = 0 ,$$

$$where$$

$${c}_{0} = 1 + {{A}_{1}^{T} ( {A}_{2}^{- 1} )}^{T} ( {A}_{2}^{- 1} ) {A}_{1} ,$$

$${c}_{1} = - 2 \cdot {{A}_{1}^{T} ( {A}_{2}^{- 1} )}^{T} ( {A}_{2}^{- 1} ) B ,$$

$${c}_{2} = {{B}^{T} ( {A}_{2}^{- 1} )}^{T} ( {A}_{2}^{- 1} ) B - 1.$$

$$then$$

$${\tilde{x}}_{1} = \frac{1}{2 {c}_{0}} \cdot ( - {c}_{1} \pm \sqrt{{c}_{1}^{2} - 4 {c}_{0} {c}_{2}} ) ,$$

$$thus$$

$$x = ( {\tilde{x}}_{1} ; {A}_{2}^{- 1} ( B - {A}_{1} {\tilde{x}}_{1} ) ) .$$

Step S307, as the system of equations met by a_{0,q}, a_{k,q}, b_{k,q}, (qₘₐₓ≥q≥2) is a linear equation set, it can be solved fast with a classic method.

Step S308, Rational approximants are derived using the series expansions of λ(s), V^{R}(s), V^{I}(s).

Step S309, a value of the rational approximant at s=s₀ is substituted into the equation (3), and a mismatch between a left side and a right side of the equation is compared to a preset acceptable threshold e to figure out whether the mismatch is smaller than the preset acceptable threshold e. If yes, s₀ is expanded till the mismatch is not smaller than the preset acceptable threshold; if no, s₀ is shrunk till the mismatch is smaller than the preset acceptable threshold. That is, s₀ as great as possible and smaller than the threshold e is found.

Step S310, (V^{R}(s₀), V^{I}(s₀), λ(s₀)) is taken as a new initial point X₀.

Step S311, S302 to S310 are repeated till an SNB point is pinpointed.

Detailed description on the preferred specific embodiments of the present invention is made above. It is to be understood that those of ordinary skill in the art can make various modifications and variations in accordance with concept of the present invention without creative efforts. Therefore, technical solutions capable of being obtained by technicians in the technical field through logical analysis, inference or limited experiments in accordance with concept of the present invention based on the prior art shall fall into the scope of protection determined by claims.

1. A fast and flexible holomorphic embedding-based method for assessing power system load margins, comprising the following steps:
step S1, acquiring required decrypted power system data from a partner indirectly;
step S2, establishing a system of continuation power flow equations;
step S3, solving the system of continuation power flow equations by FFHE; and
step S4, designing and planning a scheduling policy for the power system based on the solved load margin.

2. The fast and flexible holomorphic embedding-based method for assessing power system load margins according to claim 1, wherein the establishing a system of continuation power flow equations in step S2 specifically comprises:
a power flow problem is described as the following algebraic equations:
Sᵢ=VᵢΣₖY*_{i,k}V*ₖ, (1)
where Sᵢ=Pᵢ+jQᵢ represents a power injection at a bus, Pᵢ, Qᵢ represent active and reactive powers, respectively, at bus i, Y_{i,k}=G_{i,k}+jB_{i,k} is an admittance between corresponding buses, G_{i,k}, B_{i,k} represent a conductance and a susceptance, respectively, between corresponding buses, Y*_{i,k}, V*ₖ represent conjugates of Y_{i,k}, Vₖ, respectively, and Vᵢ represents a bus voltage; equation (1) can be converted to the rectangular form as:
Pᵢ=Vᵢ^{R}Σₖ{G_{i,k}Vₖ^{R}−B_{i,k}Vₖ^{I}}+Vᵢ^{I}Σₖ{B_{i,k}Vₖ^{R}+G_{i,k}Vₖ^{I}};
Qᵢ=−Vᵢ^{R}Σₖ{B_{i,k}Vₖ^{R}+G_{i,k}Vₖ^{I}}+VₗⁱΣₖ{G_{i,k}Vₖ^{R}−B_{i,k}Vₖ^{I}}; (2)
wherein Vₖ^{R} is a real part of the bus voltage, while Vₖ^{I} is an imaginary part of the bus voltage; and
by equation (2), a continuation power flow equation can be constructed as
Vᵢ^{R}Σₖ{G_{i,k}Vₖ^{R}−B_{i,k}Vₖ^{I}}+Vᵢ^{I}Σₖ{B_{i,k}Vₖ^{R}+G_{i,k}Vₖ^{I}}−Pᵢ−λ·(P_{targ,i}−P_{base,i})=0; (3)
−Vᵢ^{R}Σₖ{B_{i,k}Vₖ^{R}+G_{i,k}Vₖ^{I}}+Vᵢ^{I}Σₖ{G_{i,k}Vₖ^{R}−B_{i,k}Vₖ^{I}}−Qᵢ−λ·(Q_{targ,i}−Q_{base,i})=0;
wherein λ is a real number, P_{targ,i}, P_{base,i} represent a target value and a base value of the active power at a load bus, respectively, and Q_{targ,i}, Q_{base,i} represent a target value and a base value of the reactive power at the load bus, respectively.

3. The fast and flexible holomorphic embedding-based method for assessing power system load margins according to claim 1, wherein step S3 specifically comprises:
step S301, initializing and setting an order of series expansion qₘₐₓ, a threshold of the acceptable mismatch e between two sides of the equation, and a given entry of at least one part in the initial point X₀=(V^{R}(0), V^{I}(0), λ(0));
step S302, introducing a new parameter s, such as an arc-length parameter, and obtaining an embedding system;
$${\sum }_{k} \{ {( \frac{{dV}_{k}^{R}}{ds} )}^{2} ( s ) + {( \frac{{dV}_{k}^{I}}{ds} )}^{2} ( s ) \} + {( \frac{d λ}{ds} ( s ) )}^{2} = 1 ; \qquad ( 4 )$$
$${V}_{i}^{R} ( s ) {\sum }_{k} \{ {G}_{i , k} {V}_{k}^{R} ( s ) - {B}_{i , k} {V}_{k}^{I} ( s ) \} + {V}_{i}^{I} ( s ) {\sum }_{k} \{ {B}_{i , k} {V}_{k}^{R} ( s ) + {G}_{i , k}^{I} {V}_{k}^{I} ( s ) \} - {P}_{i} - λ ( s ) \cdot ( {P}_{targ , i} - {P}_{base , i} ) = 0 ;$$
$$- {V}_{i}^{R} ( s ) {\sum }_{k} \{ {B}_{i , k} {V}_{k}^{R} ( s ) + {G}_{i , k} {V}_{k}^{I} ( s ) \} + {V}_{i}^{I} ( s ) {\sum }_{k} \{ {G}_{i , k} {V}_{k}^{R} ( s ) - {B}_{i , k} {V}_{k}^{I} ( s ) \} - {Q}_{i} - λ ( s ) \cdot ( {Q}_{targ , i} - {Q}_{base , i} ) = 0 ;$$
step S303, representing λ(s), V^{R}(s), V^{I}(s) as series expansions in s;
λ(s)=Σ_{q≥0}a_{0,q}s^{q}; Vₖ^{R}(s)=Σ_{q≥0}a_{k,q}s^{q}, Vₖ^{I}(s)=Σ_{q≥0}b_{k,q}s^{q}, k≥1;
step S304, inserting the series expansion into the embedded system (4), and obtaining a system of equations by taking series coefficients in the series expansions as the unknowns:
Σ_{k≠ref}{(Σ_{q≥0}(1+q)·a_{k,q+1}s^{q})²+(Σ_{q≥0}(1+q)·b_{k,q+1}s^{q})²}+(Σ_{q≥0}(1+q)·a_{0,q+1}s^{q})=1;
{Σ_{q≥0}a_{i,q}s^{q}}·Σₖ{G_{i,k}Σ_{q≥0}a_{k,q}s^{q}−B_{i,k}Σ_{q≥0}b_{k,q}s^{q}}+{Σ_{q≥0}b_{i,q}s^{q}}·Σₖ{B_{i,k}Σ_{q≥0}a_{k,q}s^{q}+G_{i,k}Σ_{q≥0}b_{k,q}s^{q}}−Pᵢ−{Σ_{q≥0}a_{0,q}s^{q}}(P_{targ,i}−P_{base,i})=0;
{(Σ_{q≥0}a_{i,q}s^{q}}·Σₖ{B_{i,k}Σ_{q≥0}a_{k,q}s^{q}+G_{i,k}Σ_{q≥0}b_{k,q}s^{q}}+{Σ_{q≥0}b_{i,q}s^{q}}·Σₖ{G_{i,k}Σ_{q≥0}a_{k,q}s^{q}−B_{i,k}Σ_{q≥0}b_{k,q}s^{q}}−Qᵢ−{Σ_{q≥0}a_{0,q}s^{q}}·(Q_{targ,i}−Q_{base,i})=0.
step S305, comparing the coefficients of the terms with a same order of s, wherein when q=0,
a_{k,0}=Vₖ^{R}(0), b_{k,0}=Vₖ^{I}(0), 1≤k≤n; a_{0,0}=λ(0)=λ₀; a_{i,0}·Σₖ{G_{i,k}a_{k,0}−B_{i,k}b_{k,0}}+b_{i,0}·Σₖ{B_{i,k}a_{k,0}+G_{i,k}b_{k,0}}−Pᵢ−a_{0,0}·(P_{targ,i}−P_{base,i})=0;
−a_{i,0}·Σₖ{B_{i,k}a_{k,0}+G_{i,k}b_{k,0}}+b_{i,0}·Σₖ{G_{i,k}a_{k,0}−B_{i,k}b_{k,0}}−Qᵢ−a_{0,0}·(Q_{targ,i}−Q_{base,i})=0.
selecting at least one of a_{0,0}, a_{k,0}, b_{k,0} as a known initial value, to solve all a_{0,0}, a_{k,0}, b_{k,0};
step S306, comparing the coefficients of the terms with a same order of s, wherein when q=1,
Σₖ{a_{k,1}²+b_{k,1}²}+(a_{0,1})²=1 (5)
a_{i,0}·Σₖ{G_{i,k}a_{k,1}−B_{i,k}b_{k,1}}+a_{i,1}·Σₖ(G_{i,k}a_{k,0}−B_{i,k}b_{k,0})+b_{i,0}·Σₖ{B_{i,k},a_{k,1}+G_{i,k}b_{k,1}}+b_{i,1}·Σₖ{B_{i,k}a_{k,0}+G_{i,k}b_{k,0}}−a_{0,1}·(P_{targ,i}−P_{base,i})=0; (6)
−a_{i,0}·Σₖ(B_{i,k}a_{k,1}+G_{i,k}b_{k,1})−a_{i,1}·Σₖ{B_{i,k}a_{k,0}+G_{i,k}b_{k,0}}+b_{i,0}·Σₖ{G_{i,k}a_{k,1}−B_{i,k}b_{k,1}}+b_{i,1}·Σₖ(G_{i,k}a_{k,0}−B_{i,k}b_{k,0})−a_{0,1}·(Q_{targ,i}−Q_{base,i})=0; (7)
wherein a_{0,0}, a_{k,0}, b_{k,0} herein are known; in order to obtain solutions of the above-mentioned nonlinear equations (5)-(7), a novel solving method based on equivalent reduction of an equation and a quadratic formula of a quadratic equation can be utilized;
step S307, deriving rational approximants using the series expansions of λ(s), V^{R}(s), V^{I}(s);
step S308, substituting a value of the rational approximant at s=s₀ into the equation (3), and making a comparison to figure out whether the mismatch between a left side and a right side of the equation is smaller than a preset acceptable threshold e; if yes, expanding so till the mismatch is not smaller than the preset acceptable threshold; if no, shrinking s₀ till the mismatch is smaller than the preset acceptable threshold, i.e., returning s₀ as great as possible with the mismatch smaller than the threshold e;
step S309, taking (V^{R}(s₀), V^{I}(s₀), λ(s₀)) as a new initial point X₀; and
step S310, repeating step S302 to step S309 till pinpointing an SNB point.
